(19) United States
(12) Patent Application Publication
(10) Pub. No.: US 2004/0166833 A1
(43) Pub. Date: Aug. 26, 2004

(54) Mobile radio service over catv network

(76) Inventors: Dan Shklarsky, Hifa (IL); Harel Golombek, Netanya (IL)

Correspondence Address: SUGHRUE MION, PLLC, 2100 PENNSYLVANIA AVENUE, N.W., SUITE 800, WASHINGTON, DC, 20037, US

(21) Appl. No.: 10/296,042

(22) PCT Filed: Mar. 2, 2001
(86) PCT No.: PCT/US01/04939

(51) Int. Cl. H04M 11/10

(52) U.S. Cl. 455/413

(57) ABSTRACT

Passive elements in a CATV network (141) pass mobile radio network (102) signals without modification. The CATV network (141) carries both television and data as before, but also cellular or PCS signals (101). A cellular entrance module CEEM (110) provides an interface between the mobile radio terminal and the CATV network (141). Because the CATV network (141) is modified to transport the mobile radio signals, the mobile radio signals can be passed without modification to format or frequency.

### CROSS-REFERENCE TO RELATED APPLICATIONS.

This application claims the benefit of U.S. Provisional Application No. 60/206,794 filed May 25, 2000.

### BACKGROUND OF THE INVENTION.

1. Field of the invention.

The invention relates to a new topology for cellular radio networks and the like, and a method which improves the in-building coverage and capacity of a cellular or mobile radio network.

In particular, the invention relates to an extension to conventional mobile radio networks using cable networks. According to an embodiment of the invention, cable networks are merged into mobile radio networks to provide improved voice quality and coverage while enhancing network capacity. According to another embodiment of the invention, cable TV networks are used to provide in-building access for mobile radio terminals, in a mobile radio network.

2. Related work.

Mobile radio networks are conventional. A cellular radio network is an example of such a network Cellular radio networks are characterized by geographically distributed network access points, each defining cells of the network. The geographically distributed network access points are typically referred to as base stations BS or base transceiver stations BTS, and include transmission and reception equipment for transmitting signals to and receiving signals from mobile radio terminals (MT). The cells may be subdivided further, thus defining microcells.

Cells in a cellular radio network are typically linked together by a higher level entity which may be referred to as a mobile switching center (MSC) which provides certain control and switching functions for all of the BS linked to it MSC's may be linked together by a higher level entity which provides an interface to the public switched telephone network (PSTN), or may themselves have such a PSTN interface.

The conventional implementation of a cellular radio network to has had some important limitations. In particular, it is necessary in a conventional cellular radio network to build numerous cellular towers to provide geographic coverage and to solve capacity problems. The cellular towers require an important amount of real estate, and are very unsightly.

Another limitation is that, since cellular towers are expensive, and require real estate, it is economically feasible to include in a network only a limited number of them. Accordingly, the size of cells can be quite large, and it is therefore necessary to equip the mobile radio terminals with the ability to radiate at high-power so as to transmit radio signals strong enough for the geographically dispersed cellular towers to receive.

Yet another limitation to cellular radio networks as conventionally implemented is that the cellular antennas are typically located outside of buildings, even though it would be highly beneficial to provide cellular service inside buildings. The penetration of cellular signals for in- building applications requires high power sites, or additional sites or repeaters to overcome the inherent attenuation inherent with in-building penetration. Because the towers are located outside of buildings, it is difficult for mobile radio terminals to transmit signals strong enough to propagate effectively from inside of the building to outside of the building. Therefore, the use of mobile radio terminals inside buildings is usually complex and expensive.

Yet another limitation of cellular radio networks as conventionally implemented is the inherent limited capacity to provide voice and data service. This capacity shortage is due to the way the spectrum resources are allocated to each BTS. To provide for reasonable voice quality, each BTS can use only a fraction of the total spectrum owned by the cellular operator. Other BTS's could reuse the same part of the spectrum as a given BTS, but a pattern of geographic dispersion would have to be respected. This is called a frequency reuse pattern for AMPS and TDMA technologies or reuse codes pattern for CDMA technology.

One way to mitigate the above identified disadvantages of cellular radio networks is to integrate the cellular radio network with the CATV network. The CATV network is quite ubiquitous, even in rural areas. The delivery of cellular signals directly to the subscriber's premises, by using the CATV network, allows reducing the reuse factor (either frequency or code) and hence brings an increase of an order of magnitude in the cellular network's available capacity. This is due to the fact that the propagation conditions are greatly improved by using the CATV as an access path inside buildings, instead of transmitting from outdoor towers.

Various approaches have been taken in this regard.

In U.S. Pat. No. 5,805,983 (issued to Naidu), a system and method for equalizing delay times for transmission paths which connect remote antennas in a distributed antenna network, is described. The Naidu approach requires the use of remote antenna driver (RAD) nodes for converting CATV frequency signals into assigned radio frequency signals.

In U.S. Pat. No. 5,839,052 (entitled “Method and Apparatus for Integration of a Wireless Communication System with a Cable Television System”, issued to Dean et al. on Nov. 17, 1998), there is provided a set of radio antenna devices connected to the cable plant These devices provide frequency conversion and power control for signals received from the cable plant and being provided downstream to the mobile radio terminals. Frequency conversion is also performed for wireless signals received from the mobile radio terminals.

In U.S. Pat. No. 5,828,946 (entitled “CATV-Based Wireless Communications Scheme”, issued to Feisullin et al. on Oct. 27, 1998), RF mobile telephone communications signals are converted to CATV frequencies. To reduce noise in the combined upstream cable signal, only the converters that receive RF signals of a certain power level will convert them and pass them on through the CATV network.

In U.S. Pat. No. 5,822,678 (entitled “CATV Network for Transport of Radio Frequency Signals”, issued to Evanyk on Oct. 13, 1998), the existing frequency allocations for cable television are completely redefined. According to Evanyk, wireless RF signal frequencies are adjusted as well. This is disadvantageous in that it requires the replacement of current cellular telephones with ones that use a different frequency spectrum or, at the very least, modification of each received wireless RF signal. It also reduces the digital television bandwidth by 230 Mz.

In U.S. Pat. No. 5,638,422 (entitled “Distributed Antenna Personal Communication Network System”, issued to Roman on Jun. 10, 1997), antenna nodes are provided so as to interface cellular telephones with CATV networks. The nodes each include a transceiver for incoming telephone traffic on one frequency band and a separate transceiver for outgoing telephone traffic on a separate frequency band. Thus, each antenna node includes at least two transceivers. In the PCN nodes (Base Stations) in this patent, each interface the CATV plant by using the conventional standard CATV frequencies (5-30 MHz & 50-550 MHz) for the delivery of telephone traffic.

In U.S. Pat. No. 5,381,459 (entitled “System for Distributing Radiotelephone Signals over a Cable Television Network”, issued to is Lappington on Jan. 10, 1995), there is a system for distributing remote telephone traffic between a BTS and remote antenna sites. The BTS and remote antenna sites are connected via a CATV network The BTS receives from the PSTN parallel channels of outbound voice signals for radiotelephones operating within the cellular areas of the remote antenna sites. According to this approach, the BTS digitizes and time compresses each of the outbound telephone signals, and inserts them in a transmit frame which is modulated on a sub carrier and applied to the CATV network. In this approach the base station is located between at the head end cable plant and the PBX. Therefore the telephony traffic must be carried using the standard CATV frequencies, in both upstream and downstream.

In U.S. Pat. No. 5,953,670 (entitled “Arrangement for Providing Cellular Communication Via a CATV Network”, issued to Newson on Sep. 14, 1999), there is described a system in which any head end signal processor disposed at a head end of the CATV network provides a first frequency conversion between a cellular communications radio frequency and the CATV network transmission frequency. Remote antenna drivers (RAD) at the remote end of the CATV network provide a second frequency conversion between the cellular communications radio frequency and the CATV network transmission frequency.

However, all of these prior approaches to carrying wireless signals over the CATV network include re-arranging or re-packaging the original radio signal to fit into the CATV standard frequencies and channels. This is typically done by active elements, which up- and down-convert the wireless frequencies to match the known standard CATV operational frequencies. Such elements are disadvantageous, because they are necessary at each point where a CATV-to-Wireless or Wireless-to-CATV transition is needed.

### SUMMARY OF THE INVENTION.

It is an object of the invention to overcome the above-identified limitations of the present mobile networks, and the above-identified disadvantages of the related attempts to integrate mobile radio networks with CATV networks.

According to one aspect of the invention, there is provided an extension to mobile radio networks whereby a CATV network is enabled to communicate mobile radio terminal traffic. According to another aspect of the invention, there is provided a CATV network capable of communicating mobile radio terminal traffic even without connection to the analog parts of a traditional mobile radio network.

To achieve the above and other objects of the invention, the CATV network functions as an access element within the analog portion of the cellular network, namely in its RF propagation-radiation section. According to the system described herein, the capabilities of existing CATV networks are substantially preserved, but the mobile radio terminal signals do not have to be modified. That is to say, the signals sent according to the mobile radio terminal communications protocol traverse the CATV network, without modification.

The radio frequencies and channel structures of the cellular and the CATV networks are different According to the invention, the CATV network is modified so as to permit the communication of the RF signals of the mobile radio network without modification.

A traditional CATV network is a two way network having a tree topology and including cables, amplifiers, signal splitters/combiners and filters. According to one aspect of the invention, the cables and signal splitters/combiners are not modified, but the other elements are. Thus, the invention includes new components for a CATV system that permit multiband communication. The modified components allow all types of signals (the CATV up and down signals and the Cellular voice+data up and down signals) to be carried by the network simultaneously in a totally uncoupled manner (any coupling can be a source of an intolerable cross interference).

According to another aspect of the invention, there is provided a Cable Mounted Cellular Antenna (CMCA, see FIG. 4). The CMCA is a component which acts as transmit receive antenna for the cellular signals (the down link includes controlled attenuation) and as a cable input output unit for the cable network. According to an aspect of the invention, wireless RF signals are injected into the CATV network, directly, as is, without any frequency translation or any other protocol or format changes. Most of the existing CATV video signals are already limited to frequencies under 750 MHz (digital CATV goes up to 860 MHz) while cellular and PCS systems operate above this limit. Because of this, the different types of signals can coexist with the proper modification.

Since the wireless signals propagate in the CATV network while maintaining their original format, the modified CATV system components are all linear components like filters and amplifiers. This leads to a more simple, robust and affordable solution.

### BRIEF DESCRIPTION OF THE DRAWING FIGURES.

FIG. 1 shows an upgraded Cellular Cable Network (CCN) according to one embodiment of the invention.

FIG. 2 shows a simplified schematic view of a Cable Mount Cellular Antenna (CMCA) according to an embodiment of the invention.

FIG. 3 shows a simplified schematic view of a Cellular Transport Module (CETM) according to an embodiment of the invention.

FIG. 4 shows, in simplified schematic form, a Cellular Entrance Module (CEEM) according to an embodiment of the invention.

### DETAILED DESCRIPTION OF THE PREFERRED EMBODIMENTS.

The invention will now be described by way of example using one or more presently preferred embodiments. It will be understood, however, that this and the other exemplary embodiments mentioned herein are provided only for the sake of a clear explanation, and are not themselves intended to show the complete scope of the invention. The complete scope of the invention should be interpreted in the light of the appended claims.

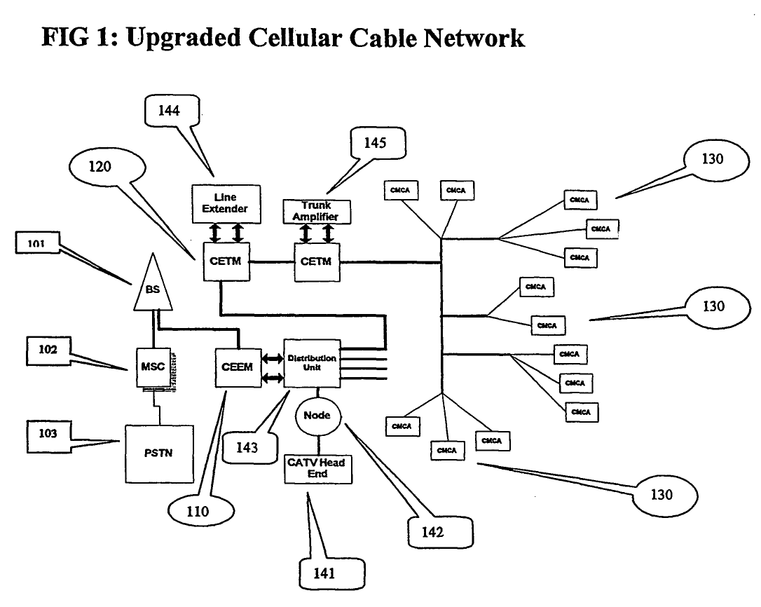

FIG. 1 shows a Cellular Entrance Module (CEEM), a Cellular Transport Module (CETM), and a Cable Mount Cellular Antenna (CMCA).

The CEEM is the interface between the Cellular network and the cable is network. Signals from the BS entering at the CEEM are distributed through the cable network. The CETM transports the Cellular signal through the cable network. The CETM is installed at any active point of the cable network, bypassing the trunk amplifiers, line extenders and distribution modules. The CMCA is the interface between the upgraded cellular cable network and the cellular head-end (end user) unit at the customer premises.

More particularly, CATV signals from the CATV head end 141 are carried out through an optical link to the optical node 142 and through coaxial cable to the distribution amplifier 143. Cellular signals (both up-link and down-link) are carried to/from the BTS 101 to the CEEM 110 which functions as the interface of the cellular signal to the upgraded cellular cable network. The CEEM 110 enable to combine both cellular and cable signal to be carried through the network. The combined signals from the CEEM 110 are connected back to the distribution amplifier 143 and the combined cellular and cable signals are carried forward through the network to the subscriber premises. The signals traveling from the distribution amplifier 143 to the CMCA 130 passing line extenders 144 trunk amplifiers 145 through the CETM 120 to the CMCA 130.

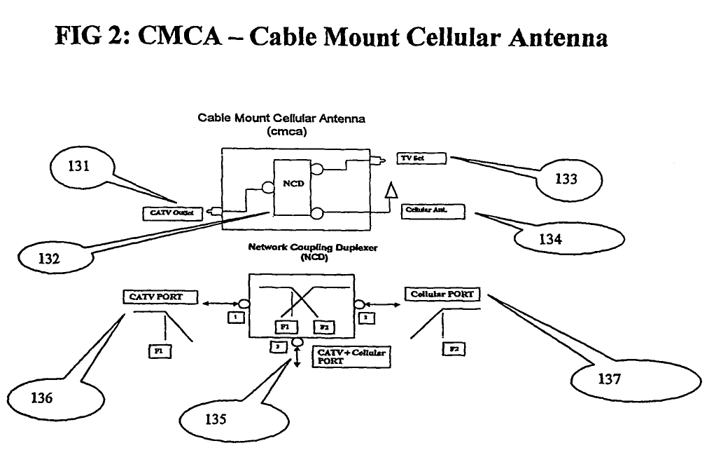

A more detailed view of the CMCA is shown in FIG. 2. The combined cellular and cable signals enter at the CATV outlet The cellular and cable signals are differentiated at the Network Coupling Duplexer (NCD). The cellular antenna connected to the NCD transmits the cellular signals, to be received by the customer cellular unit. The TV signals are connected to the TV set through the TV set outlet.

In more detail, the combined cellular and cable signals, connected at the CATV outlet 131, are carried through the NCD 132. The NCD 132 is a high pass/low pass filter that differentiates between the cellular signals to the CATV signals. The CATV signals are carried through the TV set outlet 133 to the TV. The cellular signals are carried to the cellular antenna 134 and transmitted to the customer cellular unit (not shown in the diagram). The NCD 132 high pass filter carries out all the cellular frequencies from 824 MHz (or 890 MHz in GSM) to 2 GHz where the cutoff frequency is at 750 MHz (or 860 MHz in some CATV networks). The NCD 132 law pass filter carries out all the CATV frequencies from 1 (5) to 750 MHz (or 860 MHz).

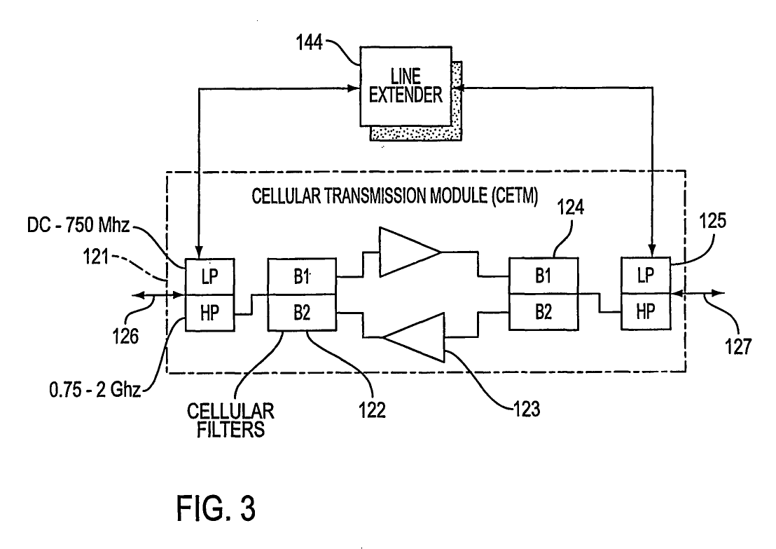

FIG. 3 depicts the CETM. The combined cellular and cable signals enter the CETM. Through the high-pass/low-pass filter (HP/LP) the signals are distributed into two different channels; one channel carries the CATV signals and the other carries the cellular signals. At the end of the path the signals are combined again through the HPI/LP to be carried through the network.

That is, the combined cellular and cable signals enter at point 126 to the LP/HP duplexer 121. The duplexers each differentiate between the CATV signals and the cellular signals. The CATV signals 5-750 MHz (860 MHz) are carried through the LP filter to the Line extender 144 or trunk amplifier 145 (see FIG. 1). The output signals from the line extender 144 are carried to an additional LP filter to be combined again with the cellular signals. The Cellular signals are carried to/from the HP output to the cellular filter 122, the cellular filter differentiates between the up-link and down-link signals to be amplified by the amplifiers 123 to balance the power budget along the pass. The cellular signals from the amplifiers 123 are connected to the HP/LP filters 125 via the fibers 124, to be combined with the CATV signals and carried on through the network.

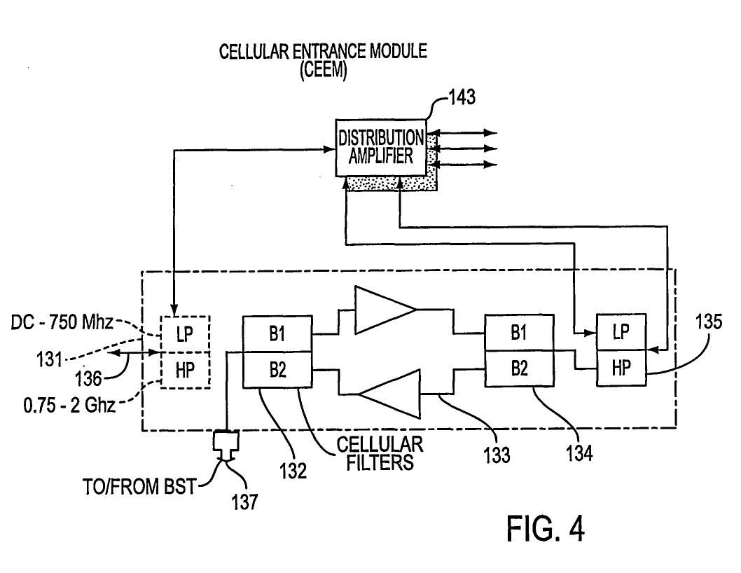

FIG. 4 shows the CEEM. The CEEM is the interface between the cellular and the cable signals. Cellular signals from the BTS are carried through the CEEM and combined through the HP/LP to the cable signals to be carried through the network.

To explain, the CATV signals from the optical node 142 are connected to the CEEM, through point 136, directly to the distribution amplifier 143 (see FIG. 1). The cellular signals to/from the BS are connected to the CEEM trough point 137 to the cellular filter 132. The cellular filter differentiates between the up-link and down-link signals to be amplified by the amplifiers 133 to balance the power budget along the pass. The cellular signals to/from the amplifiers 133 are connected to the HP/LP filters 135 via the cellular filters 134. The output from the HP/LP filters 135 is transferred back to the distribution amplifier 143 (see FIG. 1) to be distributed through all the upgraded cellular cable network.

One familiar with this field will understand that the use of the equipment and method described herein constitutes a method for enhancing the capacity of a mobile radio network. That is, the frequency (or code) reuse pattern of the network prevents the use of more than a fraction of the available spectrum in outdoor cells. With indoor cells accessed through the cellular cable network, the power of the transmitting mobile units indoors can be very low. This, coupled with the inherent attenuating effects that occur within buildings, combine to make it possible for a much more aggressive reuse pattern in indoor cells.

The various embodiments and aspects of the invention help overcome coverage and capacity constraints now faced by operators of mobile radio networks. By overcoming these coverage constrains, the cost of providing excellent radio coverage is reduced and service levels are improved. With in-building and in-home cellular coverage becoming thus inexpensive and of a high quality, more people will tend to use their cellular phones as their residential or personal phones. CATV system operators will have a potential new source of income. New service packages are possible in which CATV and mobile radio terminal service are combined.

There is claimed:

1. A method for providing bi-directional communication through a CATV network to users of wireless RF cellular service located in the vicinity of a CATV network user-end, the method comprising the steps of:
coupling original unmodified wireless RF cellular signals to an access point of the CATV network and communicating, without modification, said original unmodified wireless RF cellular signals, coupling a user interface to the user-end of the CATV network, and providing communication service through the user interface for both CATV signals and wireless RF cellular signals.

2. The method according to claim 1, wherein providing service to users further comprises the steps of:
coupling the user interface for communication with at least one cellular device by wireless RF cellular signals, and
coupling the user interface for communication with at least one CATV device by coaxial cable.

3. The method according to claim 1, further comprising the steps of:
coupling original unmodified wireless RF cellular signals to a CATV network transmitting CATV signals, and
coupling the CATV signals and the wireless RF cellular signals for simultaneous bi-directional transmission over the CATV network.

4. The method according to claim 1, wherein coupling of wireless RF cellular signals further comprises the steps of:
modifying the CATV network for coupling thereto and transmitted thereover original unmodified wireless RF cellular signals.

5. The method according to claim 1, wherein providing service through the user interface further comprises the steps of:
at the user interface:
receiving down-link wireless RF cellular signals and CATV signals from the CATV network,
decoupling CATV signals from wireless RF cellular signals,
transmitting the decoupled down-link wireless RF cellular signals over a common original unmodified air interface of the cellular network, and
receiving the wireless RF cellular signals; and
at the CATV device:
receiving the CATV signals.

6. The method according to claim 1, wherein providing service through the user interface further comprises the steps of:
at the CATV device:
transmitting up-link CATV signals;
at the cellular device:
transmitting up-link wireless RF cellular signals;
at the user interface:
receiving the wireless RF cellular signals from the cellular device over and unmodified common air interface;
receiving the CATV signals from the CATV device over a coaxial cable;
coupling the CATV signals and the wireless RF cellular signals; and
transmitting the coupled CATV and wireless RF cellular signals to the CATV network.

7. The method according to claim 1, wherein providing service through the user interface further comprises the steps of:
connecting a Cellular Entrance Module (CEEM) to an access point of the CATV network, the CEEM being configured for receiving down-link signals from the CATV network and down-link wireless RF cellular signals-from the cellular network, the CEEM performing the steps of:
coupling the CATV signals and the wireless RF cellular signals together as a separate entities, and
transmitting the CATV signals and the wireless RF cellular signals as a coupled signals; and
configuring the CEEM to provide bi-directional communication, for receiving up-link coupled signals, for decoupling CATV signals from wireless RF cellular signals, and for transmitting the decoupled signals, respectively, to the CATV network and to the cellular network.

8. The method according to claim 1, wherein providing service through the user interface further comprises the steps of:
connecting a Cable Mount Cellular Antenna (CMCA) to the user-end of the CATV network, the CMCA being configured for receiving down-link signals, and for decoupling the down-link signals into CATV signals and into wireless RF cellular signals, and
configuring the CMCA to provide bi-directional communication, for receiving separately up-link TV signals and separately up-link wireless RF cellular signals, for coupling the CATV signals with the wireless RF cellular signals and for transmitting the coupled up-link signals over the CATV network.

9. The method according to claim 8, wherein providing service through the user interface further comprises the steps of:
at the user interface:
coupling the decoupled CATV signals to a coaxial cable for transmission to at least one CATV device, the coaxial cable accommodating bi-directional communication,
coupling the decoupled wireless RF cellular signals to a cellular device, and
receiving and transmitting wireless RF cellular signals over the bi-directional antenna, respectively, to and from at least one cellular device.

10. A method for expanding bi-directional communication capability of a cellular service provider to users of the service located in a vicinity of a CATV network user-end, the method comprising the steps of:
coupling original unmodified wireless RF cellular signals to an access point of a CATV network,
coupling the wireless RF cellular signals to CATV signals,
configuring the CATV network for communication of the wireless RF cellular signals through elements thereof, and
decoupling and coupling the wireless RF cellular signals and the CATV signals for, respectively, down-link and up-link cellular communication at the user-end.

11. A method of enhancing the capacity and re-use properties of a cellular network, comprising:
providing a Cellular Entrance Module (CEEM) at an access point of said CATV network;
providing a Cable Mount Cellular Antenna (CMCA) to a user-end of said CATV network; and
providing a Cellular Transport Module (CETM) at an active point of said CATV network;
receiving, at said CEEM, unmodified wireless RF down-link signals, and, at said CMCA, unmodified wireless RF up-link signals; and
communicating said unmodified wireless RF signals between said CEEM and CMCA via said CETM.

12. The method as set forth in claim 11, wherein said CEEM performs the steps of:
receiving down-link CATV signals from said CATV network;
receiving said down-link unmodified wireless RF cellular signals from said cellular network;
coupling said down-link CATV signals and said down-link unmodified wireless RF cellular signals to provide a coupled down-link signal;
transmitting said coupled down-link signal through said CATV network;
receiving a coupled up-link signal from said CATV network;
decoupling said coupled up-link signal to provide up-link CATV signals and said up-link unmodified wireless RF cellular signals;
transmitting said up-link CATV signals to said CATV network; and
transmitting said up-link unmodified wireless RF cellular signals to said cellular network.

13. The method as set forth in claim 12, wherein said CMCA performs the steps of:
receiving up-link CATV and up-link unmodified wireless RF cellular signals, said up-link unmodified wireless RF cellular signals being received over a bi-directional antenna;
coupling said up-link CATV and up-link unmodified wireless RF cellular signals to provide said coupled up-link signal, wherein said coupling is performed without modification of said up-link unmodified wireless RF cellular signals;
transmitting said coupled up-link signal through said CATV network;
receiving said coupled down-ink signal from said CATV network;
decoupling said coupled down-link signal to provide down-link CATV and down-link unmodified wireless RF cellular signals;
transmitting said down-link CATV signals to a television signal receiver; and
transmitting said down-link unmodified wireless RF cellular signals over said bi-directional antenna to a mobile radio terminal.

14. The method as set forth in claim 13, wherein said CETM performs the steps of:
receiving, as a coupled signal, one of said coupled up-link signal and said coupled down-link signal;
differentiating between CATV signals of said coupled signal and unmodified wireless RF cellular signals of said coupled signal;
passing said CATV signals of said coupled signal through said active point of said CATV network;
passing said unmodified wireless RF cellular signals of said coupled signal around said active point of said CATV network; and
after said passing steps, recombining said CATV signals of said coupled signal with said unmodified wireless RF cellular signals of said coupled signal to provide a signal for transmission over said CATV network.
